(19) United States
(12) Patent Application Publication
(10) Pub. No.: US 2024/0104427 A1
(43) Pub. Date: Mar. 28, 2024

(54) SYSTEMS AND METHODS FOR FEDERATED LEARNING WITH HETEROGENEOUS CLIENTS VIA DATA-FREE KNOWLEDGE DISTILLATION

(71) Applicant: Toyota Motor Engineering & Manufacturing North America, Inc., Plano, TX (US)

(72) Inventors: Chianing Wang, Mountain View, CA (US); Huancheng Chen, Austin, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/953,753

(22) Filed: Sep. 27, 2022

(51) Int. Cl. G06N 20/00

(52) U.S. Cl. CPC G06N 20/00

(57) ABSTRACT

A system for training a model using federated learning is provided. The system includes a server, and a plurality of vehicles. Each of the vehicles includes a controller programmed to: transmit first knowledge data including information about a plurality of feature vectors and information about a plurality of predictions, receive first aggregated knowledge from the server, and train a local model based on the first aggregated knowledge. The server averages the first knowledge data received from the plurality of vehicles to generate the aggregated knowledge.

### TECHNICAL FIELD

The present disclosure relates to federated learning, more specifically, systems and methods for federated learning with heterogeneous clients via data-free knowledge distillation.

### BACKGROUND

In vehicular technologies, such as object detection for vehicle cameras, the distributed learning framework is still under exploration. With the rapidly growing amount of raw data collected at individual vehicles, in the aspect of user privacy, the requirement of wiping out personalized, confidential information and the concern for private data leakage motivate a machine learning model that does not require raw data transmission. In the meantime, raw data transmission to the data center becomes heavier or even infeasible or unnecessary to transmit all raw data. Without sufficient raw data transmitted to the data center due to communication bandwidth constraints or limited storage space, a centralized model cannot be designed in the conventional machine learning paradigm. Federated learning, a distributed machine learning framework, is employed when there are communication constraints and privacy issues. The model training is conducted in a distributed manner under a network of many edge clients and a centralized controller. However, the current federated learning does not consider heterogeneous edge nodes that differ in local dataset size and computation resource. In addition, although a federated learning system only transmits updates of local model instead of raw data between the server and users, the communication cost for uploading and downloading models' parameters is still remarkable especially in mobile edges.

Accordingly, a need exists for a vehicular network that takes into account heterogeneous edge nodes that differ in local dataset size and computation resource and that requires less data communication cost.

### SUMMARY

The present disclosure provides systems and methods for updating models for image processing using federated learning.

In one embodiment, a vehicle for training a model using federating learning is provided. The vehicle includes a feature extractor outputting a plurality of feature vectors in response to receiving a plurality of images, a classifier outputting a plurality of predictions in response to receiving the plurality of feature vectors, and a controller programmed to: transmit first knowledge data including information about the plurality of feature vectors and information about the plurality of predictions; receive first aggregated knowledge from the server; and train a local model including the feature extractor and the classifier based on the first aggregated knowledge.

In another embodiment, a system for training a model using federated learning is provided. The system includes a server, and a plurality of vehicles. Each of the vehicles includes a controller programmed to: transmit first knowledge data including information about a plurality of feature vectors and information about a plurality of predictions, receive first aggregated knowledge from the server, and train a local model based on the first aggregated knowledge. The server averages the first knowledge data received from the plurality of vehicles to generate the aggregated knowledge.

In another embodiment, a method for training a model in a vehicle is provided. The method includes outputting, by a feature extractor of a local model, a plurality of feature vectors in response to receiving a plurality of images; outputting, by a classifier of the local model, a plurality of predictions in response to receiving the plurality of feature vectors; transmitting the first knowledge data including information about the plurality of feature vectors and information about the plurality of predictions to a server; receiving first aggregated knowledge from the server; and training the local model based on the first aggregated knowledge.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for updating models for image processing using federated learning, in accordance with one or more embodiments shown and described herewith;

FIG. 2 depicts a schematic diagram of a system for updating models for image processing using federated learning via data-free knowledge distillation, according to one or more embodiments shown and described herein;

FIG. 3A depicts a deep learning model including a feature extractor module and a classifier module, according to one or more embodiments shown and described herein;

FIG. 3B depicts distilling data-free knowledge using the deep learning model in FIG. 3A, according to one or more embodiments shown and described herein;

FIG. 4 depicts a schematic diagram for aggregating knowledge received from edge nodes and distributing the aggregated knowledge to the edge nodes, according to one or more embodiments shown and described herein;

FIG. 5 depicts a loss function that is used to train a local modal based on local data and global knowledge, according to one or more embodiments shown and described herein;

FIG. 6 depicts example data-free knowledge distillation process, according to one or more embodiments shown and described herein;

FIG. 7 depicts a proof of concept (POC) experiment of training local models in edge nodes by communicating knowledge, according to one or more embodiments shown and described herein; and

FIG. 8 depicts the results of the POC experiment in FIG. 7, according to one or more embodiments show and described herein.

### DETAILED DESCRIPTION

The embodiments disclosed herein include systems and methods for federated learning with heterogeneous clients via data-free knowledge distillation. The system includes a server and a plurality of vehicles. Each of the vehicles includes a controller configured to: transmit first knowledge data including information about a plurality of feature vectors and information about a plurality of predictions; receive first aggregated knowledge from the server; and train a local model based on the first aggregated knowledge. The server averages the first knowledge data received from the plurality of vehicles to generate the aggregated knowledge.

The present methods and systems allow edge nodes in a federated learning system to customize their own model architecture even when a server is not able to aggregate local models from the edge nodes. In addition, communication costs are quite lower because edge nodes only upload knowledge, which is abstracted and reduced data extracted from local models, to the server and the server only broadcasts knowledge as well. Specifically, because the present system does not require the server to train its own model, the present system reduces total training time. In addition, compared to conventional federated learning where a server aggregates collected local models, the present system does not require the server to store aggregated local models. Thus, the present system saves significant memories, storages, and computing resources. Furthermore, the accuracy of the present methods and systems using data-free knowledge distillation is better than conventional vanilla federated learning algorithm (FedAvg).

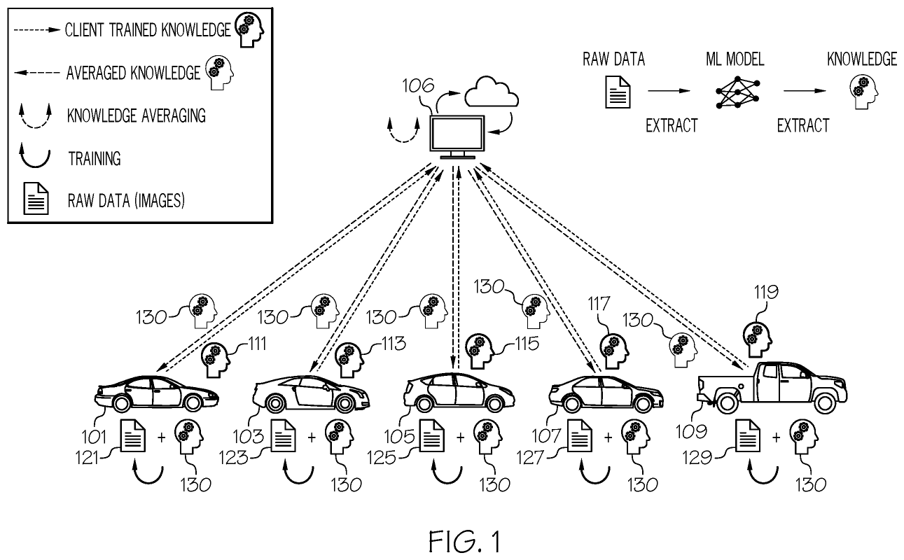

FIG. 1 schematically depicts a system for updating models for image processing using federated learning, in accordance with one or more embodiments shown and described herewith.

The system includes a plurality of edge nodes 101, 103, 105, 107, 109, and a server 106. Training for a model is conducted in a distributed manner under a network of the edge nodes 101, 103, 105, 107, and 109 and the server 106. The model may include an image processing model, an object perception model, or any other model that may be utilized by vehicles in operating the vehicles. While FIG. 1 depicts five edge nodes, the system may include more than or less than five edge nodes. Edge nodes 101, 103, 105, 107, 109 may have different datasets and different computing resources. Specifically, edge nodes 101, 103, 105, 107, 109 may be present in different areas and collect different datasets. For example, the edge node 101 may be present only in a country road and collect images that are usually obtained in the countryside. The edge node 109 may be present only in a city and collect images that are usually obtained in the city. The model may be a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning.

In embodiments, each of the edge nodes 101, 103, 105, 107, and 109 may be a vehicle, and the server 106 may be a centralized server or an edge server. The vehicle may be an automobile or any other passenger or non-passenger vehicle such as, for example, a terrestrial, aquatic, and/or airborne vehicle. The vehicle is an autonomous vehicle that navigates its environment with limited human input or without human input. In some embodiments, each of the edge nodes 101, 103, 105, 107, and 109 may be an edge server, and the server 106 may be a centralized server. In some embodiments, the edge nodes 101, 103, 105, 107, and 109 are vehicle nodes, and the vehicles may communicate with a centralized server such as the server 106 via an edge server. In some embodiments, the edge nodes 101, 103, 105, 107, 109 may be any other device, such as mobile devices, portable computers, security cameras, and the like.

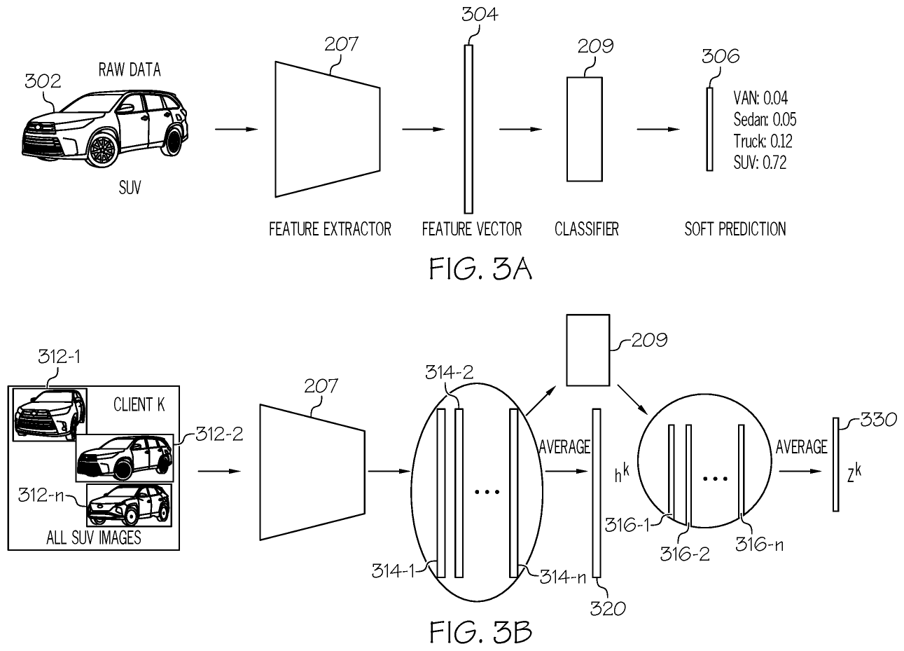

In embodiments, the server 106 sends an averaged knowledge 130 to each of the edge nodes 101, 103, 105, 107, 109. The averaged knowledge 130 may be an average of knowledge previously received from the edge nodes 101, 103, 105, 107, 109. Each of the knowledge is information that is extracted and abstracted from a machine learning model. The size of the knowledge is smaller than the size of parameters of the machine learning model. The details of obtaining knowledge will be described with reference to FIGS. 3A and 3B below. Each of the edge nodes 101, 103, 105, 107, 109 trains its local model using corresponding local data 121, 123, 125, 127, 129 and the averaged knowledge 130 received from the server 106. The local model may be any model that may be utilized for operating a vehicle, for example, an image processing model, an image segmentation model, an object detection model, an object classification model, or any other model for advanced driver assistance systems. For example, each of the edge nodes 101, 103, 105, 107, 109 may perform 2D/3D obstacle detection, traffic sign recognition, traffic light detection, bird-eye-view scene flow, monocular depth estimation, road status detection, and the like using the local model. Each of the edge nodes 101, 103, 105, 107, 109 trains its local model, extracts trained knowledge based on the trained local model and the local data, and transmits corresponding trained knowledge 111, 113, 115, 117, or 119 to the server 106.

The server 106 collects the updated trained knowledge 111, 113, 115, 117, 119, computes another averaged knowledge based on the updated trained knowledge 111, 113, 115, 117, 119, and sends another averaged knowledge to each of the edge nodes 101, 103, 105, 107, 109. Due to communication and privacy issues in vehicular object detection applications, such as dynamic mapping, self-driving, and road status detection, the federated learning framework can be an effective framework for addressing these issues in traditional centralized models. In addition, the knowledge transmitted between the edge nodes 101, 103, 105, 107, 109 and the server 106 is abstracted data extracted from the locally trained models, and thus, the size of the knowledge is smaller than the size of the locally trained model. For example, in the conventional federated learning system, edge nodes transmit model parameters to a server, and the size of model parameters may be over 2 GB for a certain model, such as ResNet 152. Because the size of the abstracted knowledge of the present disclosure is significantly smaller than the model parameters, communication consumption can be reduced by more than 90% compared to conventional vanilla federated learning. Accordingly, communication costs of the present system are quite lower compared to conventional federated learning system that communicated machine learning models because edge nodes only upload knowledge to the server and the server only broadcasts knowledge as well.

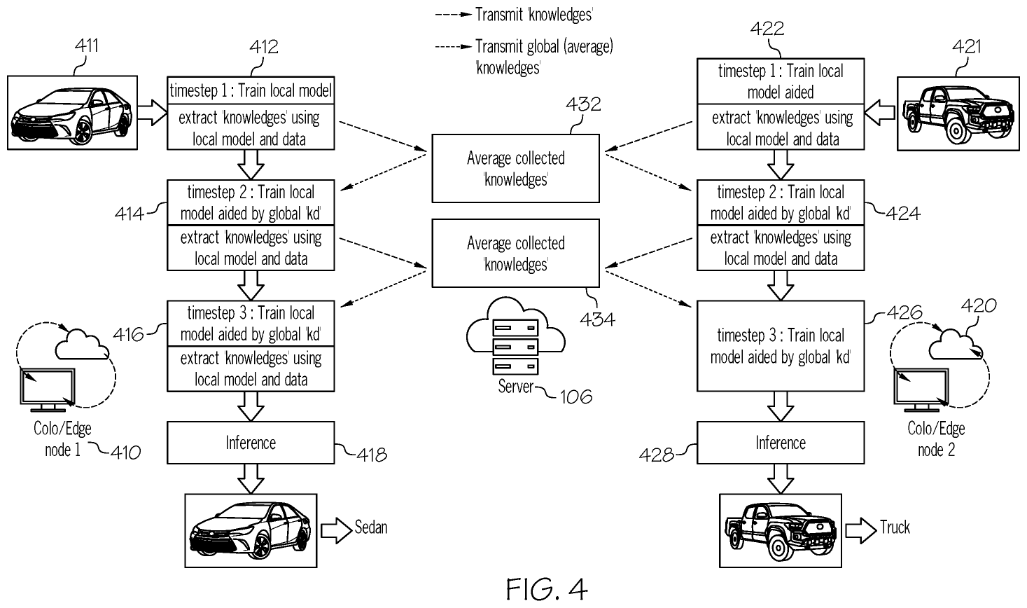

In embodiments, the server 106 considers heterogeneity of the edge nodes, i.e., different datasets and different computing resources of the edge nodes when computing aggregated knowledge based on the updated local knowledge. Details about computing global knowledge based on the updated local knowledge will be described with reference to FIGS. 4-7 below.

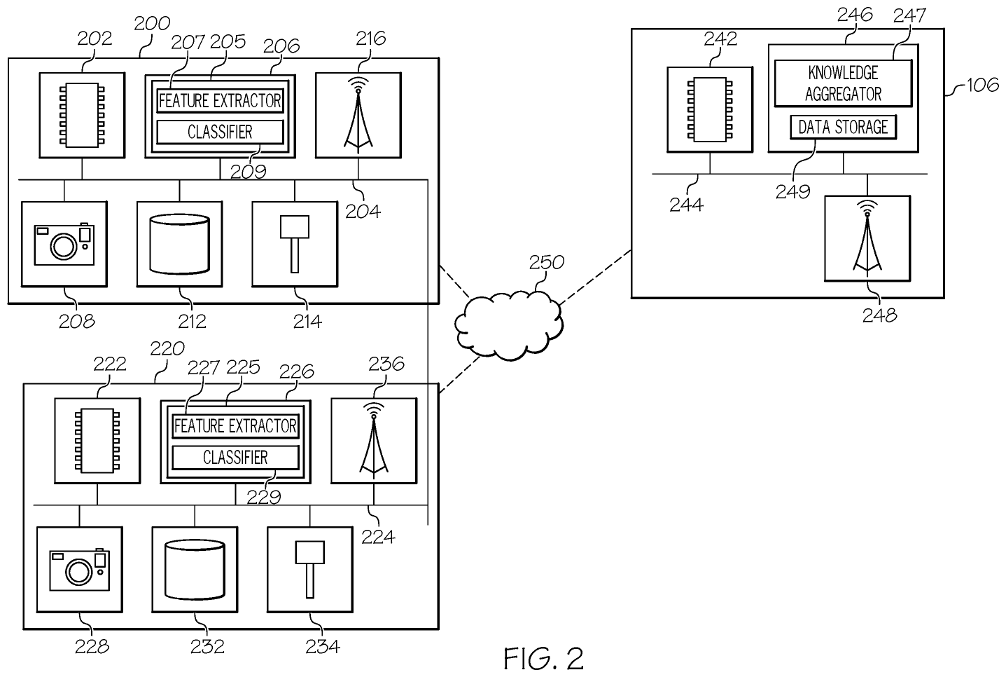

FIG. 2 depicts a schematic diagram of a system for updating models for image processing using federated learning via data-free knowledge distillation, according to one or more embodiments shown and described herein. The system includes a first edge node system 200, a second edge node system 220, and the server 106. While FIG. 2 depicts two edge node systems, more than two edge node systems may communicate with the server 106.

It is noted that, while the first edge node system 200 and the second edge node system 220 are depicted in isolation, each of the first edge node system 200 and the second edge node system 220 may be included within a vehicle in some embodiments, for example, respectively within two of the edge nodes 101, 103, 105, 107, 109 of FIG. 1. In embodiments in which each of the first edge node system 200 and the second edge node system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input. In some embodiments, the edge node may be an edge server that communicates with a plurality of vehicles in a region and communicates with a centralized server such as the server 106.

The first edge node system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first edge node system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first edge node system 200.

The one or more memory modules 206 includes a feature extractor module 207 and a classifier module 209. Each of the feature extractor module 207 and the classifier module 209 may include, but is not limited to, routines, subroutines, programs, objects, components, data structures, and the like for performing specific tasks or executing specific data types as will be described below.

The feature extractor module 207 may compress raw data, for example, compressing high dimension data into low dimension data, so called, data representation. Specifically, the feature extractor module 207 may extract features from raw data, e.g., a raw image. The extracted features may be in the form of a feature vector. The feature vector may be an abstraction of the raw image used to characterize and numerically quantify the contents of the raw image. The feature vector includes a list of numbers used to represent the raw image. For example, by referring to FIG. 3A, given an SUV image 302 with 1024*1024 resolution, the feature extractor module 207 may output data representation or a feature vector 304 with 128 values, denoting the key information of the image 302.

Referring back to FIG. 2, the classifier module 209 maps feature vectors or data representations into vectors containing likelihood of classes, so called, soft prediction. For example, by referring to FIG. 3A, the classifier module 209 receives a data representation or the feature vector 304 as an input and outputs a soft prediction, or a vector 306 with 10 values that indicate likelihood of classes. Specifically, the values indicate that the likelihood of being VAN is 4%, the likelihood of being sedan is 5%, the likelihood of being truck is 12%, and the likelihood of SUV is 72%.

Referring still to FIG. 2, the first edge node system 200 comprises one or more sensors 208. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain a rough depth and speed information for the view of the first edge node system 200.

The first edge node system 200 comprises a satellite antenna 214 coupled to the communication path 204 such that the communication path 204 communicatively couples the satellite antenna 214 to other modules of the first edge node system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first edge node system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the edge node 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first edge node system 200 comprises network interface hardware 216 for communicatively coupling the first edge node system 200 to the second edge node system 220 and/or the server 106. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first edge node system 200 may transmit its data to the second edge node system 220 or the server 106. For example, the network interface hardware 216 of the first edge node system 200 may transmit vehicle data, location data, updated local model data and the like to the server 106.

The first edge node system 200 may connect with one or more external vehicle systems (e.g., the second edge node system 220) and/or external processing devices (e.g., the server 106) via a direct connection. The direct connection may be a vehicle-to-vehicle connection (“V2V connection”), a vehicle-to-everything connection (“V2X connection”), or a mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first edge node system 200 may be communicatively coupled to the server 106 by the network 250. In one embodiment, the network 250 may include one or more computer networks (e.g., a personal area network, a local area network, or a wide area network), cellular networks, satellite networks and/or a global positioning system and combinations thereof. Accordingly, the first edge node system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second edge node system 220 includes one or more processors 222, one or more memory modules 226, a feature extractor module 227, a classifier module 229, one or more sensors 228, one or more vehicle sensors 232, a satellite antenna 234, and a communication path 224 communicatively connected to the other components of the second edge node system 220. The components of the second edge node system 220 may be structurally similar to and have similar functions as the corresponding components of the first edge node system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, the feature extractor module 227 corresponds to the feature extractor module 207, and the classifier module 229 corresponds to the classifier module 209).

Still referring to FIG. 2, the server 106 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The one or more memory modules 246 may include a knowledge aggregator module 247 and a data storage 249. The knowledge aggregator module 247 may include, but is not limited to, routines, subroutines, programs, objects, components, data structures, and the like for performing specific tasks or executing specific data types as will be described below.

The knowledge aggregator module 247 aggregates local knowledge received from edge nodes and transmits the aggregated knowledge to the edge nodes. The details about obtaining aggregated knowledge will be described with reference to FIG. 4 below.

FIG. 3A depicts predicting a classification of an image using a feature extractor module and a classifier module of a deep learning model, according to one or more embodiments shown and described herein.

The feature extractor module 207 and the classifier module 209 constitute a learning model. The feature extractor module 207 may receive, as an input, raw data, e.g., an image of SUV that is captured by one or more sensors 208 of the first edge node system 200. Then, the feature extractor module 207 may extract features from the raw data. The extracted features may be in the form of a feature vector. For example, given the SUV image 302 with 1024*1024 resolution, the feature extractor module 207 may output data representation or a feature vector 304 with 128 values, denoting the key information of the SUV image 302.

The classifier module 209 may receive, as an input, the feature vector 304 and maps the feature vector or data representation into a vector 306 containing values of likelihood of classes. This mapping is called soft prediction. For example, the vector 306 may include 10 values for 10 categories (VAN, sedan, truck, SUV, motorcycle, RV, etc.) of a vehicle. The values may represent the likelihood of corresponding category. For example, the vector 306 includes values such as 0.04 for VAN, 0.05 for sedan, 0.12 for truck, 0.72 for SUV, which indicates that the likelihood of VAN is 4%, the likelihood of sedan is 5%, the likelihood of truck is 12%, and the likelihood of SUV is 72%.

FIG. 3B depicts extracting knowledge using the feature extractor module and the classifier module, according to one or more embodiments shown and described herein.

The feature extractor module 207 may receive, as inputs, a plurality of images, e.g., SUV images that are captured by one or more sensors 208 of the first edge node system 200. Then, the feature extractor module 207 may extract features from each of the plurality of images. Each of the extracted features may be in the form of a feature vector. For example, for the image 312-1, 312-2, . . . , 312-n, the feature extractor module 207 may output feature vectors 314-1, 314-2, . . . , 314-n, respectively. Then, the processor 202 of the first edge node system 200 may average the feature vectors 314-1, 314-2, . . . , 314-n to obtain an averaged feature vector 320.

The classifier module 209 may receive, as inputs, the plurality of feature vectors 314-1, 314-2, . . . , 314-n and map the feature vectors or data representations into a plurality of vectors 316-2, 316-2, . . . , 316-n. Each of the plurality of vectors 316-2, 316-2, . . . , 316-n contains likelihood of classes. Then, the processor 202 of the first edge node system 200 may average the vectors 316-1, 316-2, . . . , 316-n to obtain an averaged vector 330. A set of the averaged feature vector 320 and the averaged vector 330 constitutes knowledge for classifying SUVs. In some embodiments, the processor 202 of the first edge node system 200 may obtain the feature vector 330 by weighted-averaging of the vectors 316-1, 316-2, . . . , 316-n. The knowledge includes mapping between the average of the plurality of feature vectors 314-1, 314-2, . . . , 314-n and the average of the plurality of vectors 316-2, 316-2, . . . , 316-n, or predictions.

While FIG. 3B depicts generating knowledge for classifying SUVs based on images, other knowledge may be generated using different sets of images. For example, knowledge for classifying sedans, trucks, motorcycles, pedestrians, animals, and the like may be also generated by edge nodes. Because the system may include heterogeneous edge nodes, different edge nodes may generate different knowledge for different objects that are detected by corresponding edge nodes.

FIG. 4 depicts a schematic diagram for aggregating knowledge received from edge nodes and distributing the aggregated knowledge to the edge nodes. Specifically, the sever 160 communicates with a first edge node 410 and a second edge node 420. The first edge node 410 and the second edge node 420 may correspond to the first edge node system 200 and the second edge node system 220 in FIG. 2. The first edge node 410 trains its local model using local data such as images 411 for a certain number of steps, e.g., 2,000 steps at step 412. Similarly, the second edge node 420 trains its local model using local data such as images 421 for a certain number of steps, e.g., 2,000 steps at step 422. After the certain number of steps, each of the first edge node 410 and the second edge node 420 extracts knowledge using the trained local model and the local data and transmits the extracted knowledge to the server 160. The knowledge may include an averaged feature vector and an averaged vector as illustrated in FIG. 3B. The knowledge aggregator module 247 of the server 160 averages the collected knowledge received from the first edge node 410 and the second edge node 420 to obtain global aggregated knowledge at step 432. The server 160 transmits the global aggregated knowledge to each of the first edge node 410 and the second edge node 420.

Then, each of the first edge node 410 and the second edge node 420 repeats local training using the received global aggregated knowledge. Specifically, the first edge node 410 trains its local model using the global aggregate knowledge and local data for another 2,000 steps at step 414. Similarly, the second edge node 420 trains its local model using the global aggregated knowledge and local data for another 2,000 steps at step 424. Then, each of the first edge node 410 and the second edge node 420 extracts knowledge using the trained local model and the local data and transmits the extracted knowledge to the server 160. The knowledge aggregator module 247 of the server 160 averages the knowledge received from the first edge node 410 and the second edge node 420 to obtain global aggregated knowledge at step 434. The server 160 transmits the global aggregated knowledge to each of the first edge node 410 and the second edge node 420. Each of the first edge node 410 and the second edge node 420 trains its local model using the received global aggregated knowledge and local data and extracts knowledge using the trained local model and local data at steps 416 and 426, respectively. The first edge node 410 may infer objects in a captured image using its updated local model and/or extracted knowledge at step 418. Similarly, the second edge node 420 may infer objects in a captured image using its updated local model and/or extracted knowledge at step 428.

While FIG. 4 depicts that the frequencies of uploading the compressing data by the first edge node 410 and the second edge node 420 are the same, the frequencies may be different based on different computing resources of the first edge node 410 and the second edge node 420. Regarding averaging knowledge received from the edge nodes 410 and 420, the server 160 may give different weights to different knowledge based on the amount of dataset that each of the first edge node 410 and the second edge node 420 retains.

While FIG. 4 depicts that the server 106 communicates with two edge nodes 410 and 420, the server 106 may communicate with more than two edge nodes.

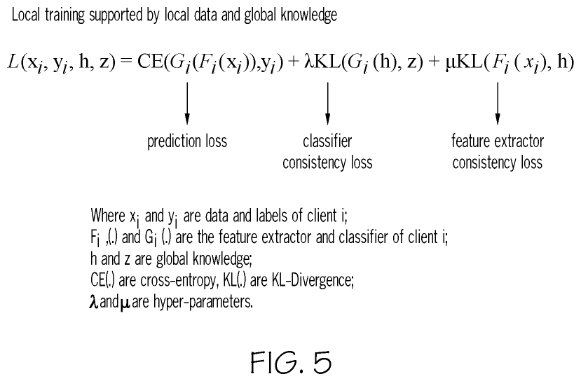

FIG. 5 depicts a loss function that is used to train a local modal based on local data and global knowledge, according to one or more embodiments shown and described herein.

The loss function L( ) is prepared in order to train a local model. The local model may be trained to reduce the value of the loss function L( ). A loss function is usually a distance measurement between prediction and ground-truth. Deep learning is essentially a procedure to find appropriate model's parameters to have very small loss function L( ) with a plurality of input data samples. The loss function L( ) of local training is shown in FIG. 5.

The first term, CE(Gᵢ(Fᵢ(xᵢ)), yᵢ), represents a prediction loss. The first term is the same as federated average, FedAvg, (the vanilla federated learning method), i.e., cross-entropy loss between prediction and ground-truth. The second term, λKL(Gᵢ(h), z), represents a consistency loss to force a local classifier module to output similar prediction to other users' classifier modules. The third term, μKL(Fᵢ(xᵢ), h), is a consistency loss to force the local feature extractor module to output similar data representations to other users' feature extractor modules. The second and third terms are the key to utilize the averaged knowledge from the server.

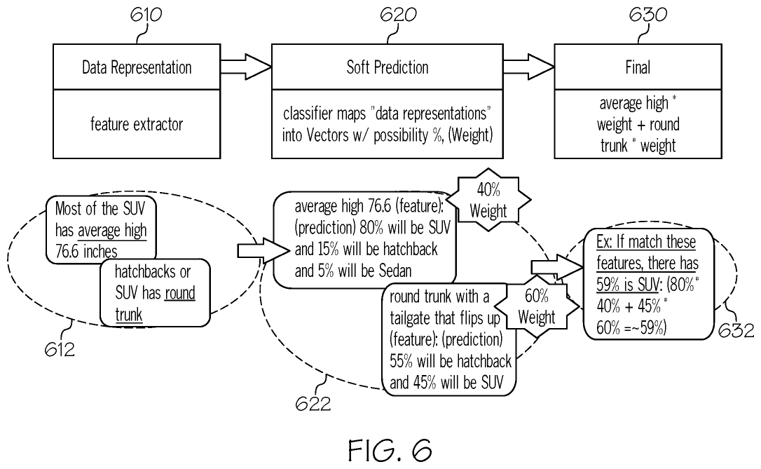

FIG. 6 depicts example data-free knowledge distillation process, according to one or more embodiments shown and described herein.

Specifically, the feature extractor module may extract features or data representation 610 from a plurality of images. Two examples of features 612 are depicted in FIG. 6. One feature may indicate that most of SUVs have an average height of 76.6 inches. Another feature may indicate that the shape of a trunk for hatchbacks or SUVs is round. The classifier module maps the data representation into soft prediction 620, e.g., vectors with possibility of classifications. For example, the classifier module maps the data representation of average height of 76.6 inches into soft predictions that the possibility that the object in an image would be an SUV is 80%, the possibility that the object in an image would be hatchback is 15%, and the possibility that the object in an image would be a sedan is 5%. As another example, the classifier module maps the data representation of a round trunk with a tailgate that flips up into soft predictions that the possibility that the object in an image would be a hatchback is 55% and the possibility that the object in an image would be an SUV is 45%.

Then, aggregated knowledge 630 may be obtained for the data presentations and the soft predictions by averaging the soft predictions with weights. First, based on the ground truth data and calibration, weights for the soft predictions may be determined. For example, 40 percent weight is assigned to the soft prediction that for an average height of 76.6 inches, 80% will be SUV, 15% will be hatchback, and 5% will be sedan. In addition, 60 percent weight is assigned to the soft prediction that for a round trunk with a tailgate that flips up, 55% will be hatchback and 45% will be SUV. Then, final knowledge 632 may be created based on weighted sum of the soft predictions. Specifically, the final knowledge 632 would be that if an height of a vehicle is 76.6 inches and the vehicle has a round trunk with a tailgate that flips up, the probability that the vehicle would be an SUV is 59%, which is calculated from 80%*40%+45%*60%.

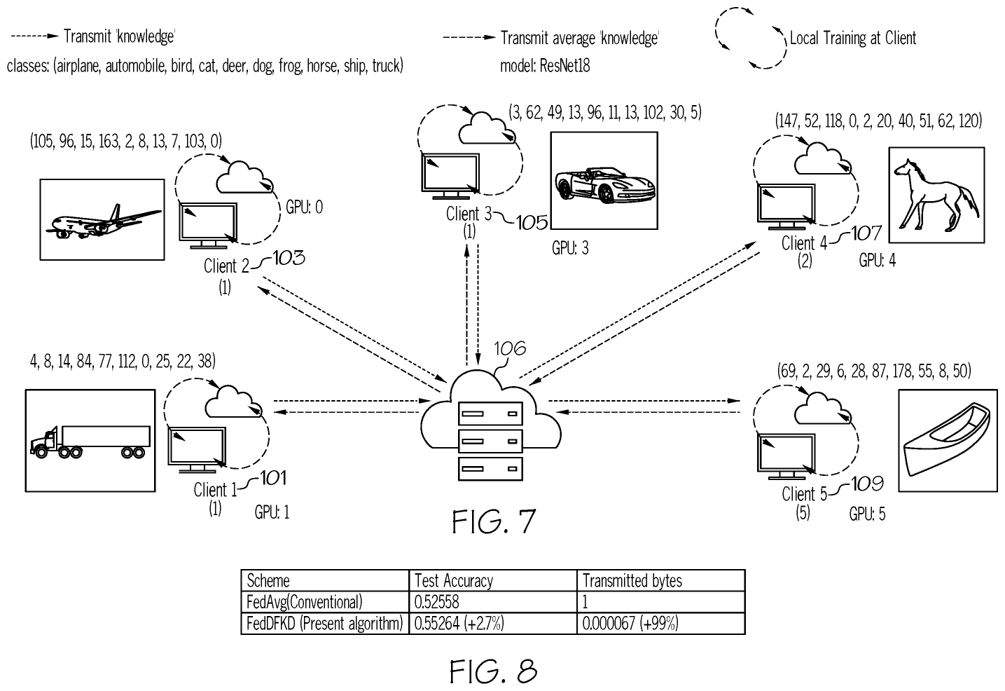

FIG. 7 depicts a proof of concept (POC) experiment of training local models in edge nodes by communicating knowledge, according to one or more embodiments shown and described herein.

The server 160 obtains information about a computation resource in each of a plurality of edge nodes 101, 103, 105, 107, 109. The computation resource may be a computing power of a CPU or a GPU. The edge nodes 101, 103, 105, 107, 109 have different computation resources. For example, the edge node 101 has one GPU, the edge node 103 includes zero GPU, the edge node 105 includes three GPUs, the edge node 107 includes four GPUs, and the edge node 109 includes five GPUs.

Each of the edge nodes 101, 103, 105, 107, 109 trains its local model using local data. Classes that are trained include airplane, automobile, bird, cat, deer, dog, frog, horse, ship, truck. The numbers in the brackets represent the number of images corresponding to classes being trained. For example, for the edge node 101, four airplane images, eight automobile images, 14 bird images, 84 cat images, 77 deer images, 112 dog images, zero frog image, 25 horse images, 22 ship images, and 38 truck images are used as local data for training the local model. Similarly, for the edge node 103, 105 airplane images, 96 automobile images, 15 bird images, 163 cat images, 2 deer images, 8 dog images, 13 frog image, 7 horse images, 103 ship images, and zero truck images are used as local data for training the local model. The edge nodes 105, 107, 109 have different sets of images for training corresponding model.

Each of the edge nodes 101, 103, 105, 107, 109 extracts its local knowledge from the trained local model and the local data and transmits the extracted knowledge to the server 106. The server 106 averages the knowledge receives from the edge nodes 101, 103, 105, 107, 109 and transmits the averaged knowledge to the edge nodes 101, 103, 105, 107, 109.

FIG. 8 depicts the results of the POC experiment in FIG. 7, according to one or more embodiments show and described herein.

The POC result shows that the present system utilizing data-free knowledge distillation outperforms conventional federated averaging method. Specifically, the test accuracy of the present system is 0.55264 compared to 0.52558 of the conventional federated averaging scheme. That is, the present system results in 2.7% improvement on test accuracy. In addition, the present system reduces communication costs significantly compared to the conventional system. Specifically, for 1 byte transmitted by the convention system, the present system only transmits 0.000067 byte, which reduces communication costs by more than 99%. That is, the present system provided enhanced accuracy of object detection/classification even with reduced data transmission.

It should be understood that embodiments described herein are directed to a system for updating models in edge nodes using data-free knowledge. The system includes a controller programmed to obtain information about a computation resource in each of a plurality of edge nodes, assign training steps to the plurality of edge nodes based on the information about the computation resource, determine frequencies of uploading local model parameters for the plurality of edge nodes based on the assigned training steps, receive local model parameters from one or more of the plurality of edge nodes based on the determined frequencies, and update a global model based on the received local model parameters.

The present methods and systems for updating models using federated learning provides several advantages over conventional schemes. The present methods and systems allow edge nodes in a federated learning system to customize their own model architecture even when a server is not able to aggregate local models from the edge nodes. In addition, communication costs are quite lower because edge nodes only upload knowledge, which is abstracted and reduced data of local models, to the server and the server only broadcasts knowledge as well. Furthermore, the accuracy of the present methods and systems using data-free knowledge distillation is better than conventional vanilla federated learning algorithm (FedAvg). Specifically, the data-free knowledge distillation federated leaning of the present system show less validation performs drop for data-heterogeneous edges compared to conventional federated learning.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a feature extractor outputting a plurality of feature vectors in response to receiving a plurality of images;
a classifier outputting a plurality of predictions in response to receiving the plurality of feature vectors; and
a controller programmed to:
transmit first knowledge data including information about the plurality of feature vectors and information about the plurality of predictions to a server;
receive first aggregated knowledge from the server; and
train a local model including the feature extractor and the classifier based on the first aggregated knowledge.

2. The vehicle according to claim 1, wherein the information about the plurality of feature vectors includes an average of the plurality of feature vectors and the information about the plurality of predictions includes an average of the plurality of the predictions.

3. The vehicle according to claim 2, wherein the first knowledge data includes mapping between the average of the plurality of feature vectors and the average of the plurality of predictions.

4. The vehicles according to claim 1, wherein the plurality of predictions are prediction vectors, and
each of the prediction vectors includes probabilities of classifications of objects.

5. The vehicle according to claim 1, wherein the local model is a machine learning model for classifying objects, and
a size of the first knowledge data is smaller than a size of the local model.

6. The vehicle according to claim 1, wherein the controller is further programmed to:
train the local model by minimizing a total of a prediction loss, a classifier consistency loss, and a feature extractor consistency loss.

7. The vehicle according to claim 1, wherein the controller is further programmed to:
extract second knowledge data based on the trained model and local data;
transmit the second knowledge data to the server;
receive second aggregated knowledge from the server; and
train the trained local model further based on the second aggregated knowledge.

8. The vehicle according to claim 1, further comprising:
an imaging sensor configured to capture the plurality of images.

9. A system for training a model, the system comprising:
a server; and
a plurality of vehicles, each of the vehicles comprising:
a controller programmed to:
transmit first knowledge data including information about a plurality of feature vectors and information about a plurality of predictions to a server;
receive first aggregated knowledge from the server; and
train a local model based on the first aggregated knowledge,
wherein the server averages the first knowledge data received from the plurality of vehicles to generate the aggregated knowledge.

10. The system according to claim 9, wherein each of the vehicles comprises:
a feature extractor configured to output the plurality of feature vectors in response to receiving a plurality of images;
a classifier configured to output the plurality of predictions in response to receiving the plurality of feature vectors.

11. The system according to claim 9, wherein the information about the plurality of feature vectors includes an average of the plurality of feature vectors and the information about the plurality of predictions includes an average of the plurality of predictions.

12. The system according to claim 11, wherein the first knowledge data includes mapping between the average of the plurality of feature vectors and the average of the plurality of predictions.

13. The system according to claim 9, wherein the plurality of predictions are prediction vectors, and
each of the prediction vectors includes probabilities of classifications of objects.

14. The system according to claim 9, wherein the local model is a machine learning model for classifying objects, and
a size of the knowledge data is smaller than a size of the local model.

15. The system according to claim 9, wherein the controller is further programmed to:
train the local model by minimizing a total of a prediction loss, a classifier consistency loss, and a feature extractor consistency loss.

16. The system according to claim 9, wherein the controller is further programmed to:
extract second knowledge data based on the trained model and local data;
transmit the second knowledge data to the server;
receive second aggregated knowledge from the server; and
train further the trained local model based on the second aggregated knowledge.

17. A method for training a model in a vehicle, the method comprising:
outputting, by a feature extractor of a local model, a plurality of feature vectors in response to receiving a plurality of images;
outputting, by a classifier of the local model, a plurality of predictions in response to receiving the plurality of feature vectors;
transmitting knowledge data including information about the plurality of feature vectors and information about the plurality of predictions to a server;
receiving aggregated knowledge from the server; and
training the local model based on the aggregated knowledge.

18. The method according to claim 17, wherein the information about the plurality of feature vectors includes an average of the plurality of feature vectors and the information about the plurality of predictions includes an average of the plurality of predictions.

19. The method according to claim 18, wherein the knowledge data includes mapping between the average of the plurality of feature vectors and the average of the plurality of predictions to a server.

20. The method according to claim 17, further comprising:
training the local model by minimizing a total of a prediction loss, a classifier consistency loss, and a feature extractor consistency loss.
